(19) United States
(12) Patent Application Publication
(10) Pub. No.: US 2026/0196159 A1
(43) Pub. Date: Jul. 9, 2026

(54) DISPLAY SUBSTRATE AND DISPLAY APPARATUS

(71) Applicants: Chengdu BOE Optoelectronics Technology Co., Ltd., Chengdu, Sichuan (CN); BOE Technology Group Co., Ltd., Beijing (CN)

(72) Inventors: Maoying LIAO, Beijing (CN); Zhiwen CHU, Beijing (CN); Huijuan YANG, Beijing (CN); Liheng WEI, Beijing (CN); Yiding WANG, Beijing (CN); Peng XU, Beijing (CN); Wei WANG, Beijing (CN); Yi ZHANG, Beijing (CN); Xing YAO, Beijing (CN)

(21) Appl. No.: 18/864,536

(22) PCT Filed: Sep. 7, 2023
(86) PCT No.: PCT/CN2023/117405

§ 371 Date: Nov. 10, 2024

(51) Int. Cl. G09G 3/32

(52) U.S. Cl. CPC G09G 3/32; G09G 2300/0408; G09G 2300/0819; G09G 2310/0267; G09G 2320/0233

(57) ABSTRACT

A display substrate and a display apparatus are provided and belong to the field of display technology. The display substrate includes a gate driving circuit and clock signal lines. The gate driving circuit includes cascaded gate driving units; the clock signal lines are divided into N groups, and each group includes two clock signal lines; for any two adjacent gate driving units in every 2N cascaded gate driving units, a first clock signal terminal of an ith gate driving unit is connected to an ith clock signal line, a second clock signal terminal of the ith gate driving unit is connected to an (i+1)th clock signal line, where i is a positive integer in a range from 1 to (2N−1), and a timing sequence of the ith clock signal line is opposite to that of the (i+1)th clock signal line; and a first clock signal terminal of a 2N-th gate driving unit is connected to a 2N-th clock signal line, a second clock signal terminal of the 2N-th gate driving unit is connected to a first clock signal line, and a timing sequence of the 2N-th clock signal line is opposite to that of the first clock signal line.

### TECHNICAL FIELD

The present disclosure relates to the field of display technology, and in particular to a display substrate and a display apparatus.

### BACKGROUND

The gate drive on array (GOA) technology of an array substrate is a common technology in a display product at present where a gate driving circuit is formed on a substrate to realize a driving mode of scanning pixel gates (Gates) line by line.

At present, a display apparatus increasingly tends towards having a large size, and a size and a resolution of the display apparatus are increased, so that paths where various signal lines are routed are longer, and loading of clock signal lines connected to a gate driving circuit are increased. The time of outputting signals by the gate driving circuit is increased due to the increase of the loading, so that the effective operation time of pixels is adversely affected, and a display picture is adversely affected.

### SUMMARY

The present disclosure is directed to solving at least one of the technical problems in the related art and provides a display substrate and a display apparatus.

In a first aspect, the technical solution adopted for solving the technical problems of the present disclosure is a display substrate, including a base substrate, and a gate driving circuit and a plurality of clock signal lines arranged on the base substrate, wherein the gate driving circuit includes a plurality of cascaded gate driving units; the plurality of clock signal lines are divided into N groups, and each group includes two clock signal lines, where N is a positive integer greater than or equal to 2; for any two adjacent gate driving units in every 2N cascaded gate driving units, a first clock signal terminal of an ith gate driving unit is connected to an ith clock signal line, a second clock signal terminal of the ith gate driving unit is connected to an (i+1)th clock signal line, where i is a positive integer in a range from 1 to (2N−1), the clock signal lines connected to the first clock signal terminals are different from each other, the clock signal lines connected to the second clock signal terminals are different from each other, and a timing sequence of the ith clock signal line is opposite to that of the (i+1)th clock signal line; and a first clock signal terminal of a 2N-th gate driving unit is connected to a 2N-th clock signal line, a second clock signal terminal of the 2N-th gate driving unit is connected to a first clock signal line, and a timing sequence of the 2N-th clock signal line is opposite to that of the first clock signal line.

In some embodiments, the plurality of cascaded gate driving units are arranged side by side along a second direction; and any one of the plurality of clock signal lines extends along the second direction, and an orthographic projection of each of the clock signal lines in any one group on the base substrate overlaps with an orthographic projection of each gate driving unit on the base substrate.

In some embodiments, the display substrate further includes a driving circuit layer on the base substrate, and a first conductive layer on a side of the driving circuit layer away from the base substrate; and the plurality of clock signal lines are located in the first conductive layer.

In some embodiments, the display substrate further includes a light emitting device and a third power line, and the third power line is connected to the light emitting device; the third power line includes a first conductive portion, a second conductive portion, and a third conductive portion connecting the first conductive portion and the second conductive portion, and the first conductive portion and the third conductive portion are both located in the first conductive layer; and the display substrate further includes a second conductive layer located between the first conductive layer and the driving circuit layer, and the second conductive portion is located in the second conductive layer, is connected to the first conductive portion through a first connecting via, and is connected to the third conductive portion through a second connecting via.

In some embodiments, the second conductive portion includes a first end, a second end, and main portions connected between the first end and the second end, and an orthographic projection of the main portions on the base substrate is located between an orthographic projection of the first conductive portion on the base substrate and an orthographic projection of the third conductive portion on the base substrate.

In some embodiments, each gate driving unit includes an output circuit and an output control circuit; and the orthographic projection of the main portions on the base substrate does not overlap with orthographic projections of the output circuit and the output control circuit in the gate driving circuit on the base substrate.

In some embodiments, the display substrate further includes a planarization layer between the first conductive layer and the second conductive layer, and the first connecting via and the second connecting via penetrate through the planarization layer, respectively; and the planarization layer has a thickness between 1.5 μm and 2.0 μm.

In some embodiments, the display substrate further includes a first power line configured to transmit a first voltage signal to the gate driving circuit, a second power line configured to transmit a second voltage signal to the gate driving circuit, and an input signal line configured to supply an input signal to the gate driving circuit; and the first power line, the second power line, and the input signal line are all located in the second conductive layer

In some embodiments, the display substrate includes a display region and a non-display region, the first power line, the second power line, the second conductive portion, and the input signal line are located in the non-display region, the first power line is located on a side of the second conductive portion away from the display region, and the second power line is located on a side of the second conductive portion close to the display region; and the input signal line is located between the second power line and the second conductive portion.

In some embodiments, the driving circuit layer includes a semiconductor layer, a third conductive layer, a fourth conductive layer, and a fifth conductive layer sequentially arranged on the base substrate; active layers of transistors in the gate driving circuit are located in the semiconductor layer; control electrodes of the transistors, a first plate of a first capacitor and a first plate of a second capacitor in the gate driving circuit are all located in the third conductive layer; a second plate of the first capacitor and a second plate of the second capacitor in the gate driving circuit are both located in the fourth conductive layer; and first electrodes and second electrodes of the transistors in the gate driving circuit are all located in the fifth conductive layer.

In some embodiments, each gate driving unit includes a first transistor, a second transistor, a third transistor, a fourth transistor, a fifth transistor, a sixth transistor, a seventh transistor, and an eighth transistor; and the fourth conductive layer further includes a first adapter electrode for connecting a control electrode of the sixth transistor and a first electrode of the second transistor.

In some embodiments, each gate driving unit includes a first transistor, a second transistor, a third transistor, a fourth transistor, a fifth transistor, a sixth transistor, a seventh transistor, and an eighth transistor; and a control electrode of the third transistor and a control electrode of the first transistor are connected together to have a one-piece structure, which is connected to a second electrode of the second transistor, and the second electrode of the second transistor is further used as a first clock signal terminal of the gate driving unit.

In some embodiments, the fifth conductive layer further includes a second adapter electrode, and the second adapter electrode is further used as the second clock signal terminal of the ith gate driving unit and the first clock signal terminal of the (i+1)th gate driving unit, and is connected to a control electrode of the seventh transistor of the ith gate driving unit, a control electrode of the first transistor and a control electrode of the third transistor of the (i+1)th gate driving unit.

In some embodiments, the fifth conductive layer further includes a third adapter electrode connected to a control electrode of the eighth transistor of the ith gate driving unit and a second electrode of the third transistor of the (i+1)th gate driving unit.

In some embodiments, the fifth conductive layer further includes a fourth adapter electrode, and the fourth adapter electrode is further used as an output terminal of the ith gate driving unit and an input terminal of the (i+1)th gate driving unit, and is connected to a second electrode of the fifth transistor and a second electrode of the fourth transistor of the ith gate driving unit, and a second electrode of the first transistor of the (i+1)th gate driving unit.

In some embodiments, each gate driving unit includes a first transistor, a second transistor, a third transistor, a fourth transistor, a fifth transistor, a sixth transistor, a seventh transistor, and an eighth transistor; an active layer of the fourth transistor and an active layer of the fifth transistor are in common, and the active layer of the fourth transistor includes a first semiconductor, a second semiconductor, and a third semiconductor arranged side by side and at intervals in the first direction; orthographic projections of the first semiconductor, the second semiconductor and the third semiconductor on the base substrate overlap with an orthographic projection of a control electrode of the fourth transistor on the base substrate, respectively; and the orthographic projections of the first semiconductor, the second semiconductor and the third semiconductor on the base substrate overlap with an orthographic projection of a control electrode of the fifth transistor on the base substrate, respectively.

In some embodiments, the first conductive portion includes a plurality of openings penetrating through the first conductive portion in a thickness direction of the first conductive portion, the plurality of openings include a plurality of columns of openings, multiple openings are arranged side by side in a second direction, to form a column of openings, and the plurality of columns of openings are arranged side by side along the first direction.

In some embodiments, the display substrate includes a display region and a non-display region, and initialization signal lines located in the non-display region and pixel driving circuits located in the display region; and the initialization signal lines are located in the second conductive layer and connected to the pixel driving circuits.

In a second aspect, the embodiment of the present disclosure further provides a display apparatus, including the display substrate according to any one of the embodiments in the first aspect.

### BRIEF DESCRIPTION OF DRAWINGS

FIG. 1 is a schematic diagram of an 8T1C pixel driving circuit in the related art;

FIG. 2 is an ideal output waveform diagram of the circuit shown in FIG. 1;

FIG. 3 is an actual output waveform diagram of the circuit shown in FIG. 1;

FIG. 4 is a schematic diagram of cascaded gate driving units in the related art;

FIG. 5 is a schematic diagram of a structure of a display substrate according to an embodiment of the present disclosure;

FIG. 6 is a plan view of stacked layers of a gate driving circuit according to an embodiment of the present disclosure;

FIG. 7 is a plan view of a first conductive layer and a second conductive layer stacked together according to an embodiment of the present disclosure;

FIG. 8 is a plan view of a first conductive layer according to an embodiment of the present disclosure;

FIG. 9 is a plan view of a second conductive layer according to an embodiment of the present disclosure;

FIG. 10 is a plan view of a semiconductor layer according to an embodiment of the present disclosure;

FIG. 11 is a plan view of a third conductive layer according to an embodiment of the present disclosure;

FIG. 12 is a plan view of a fourth conductive layer according to an embodiment of the present disclosure;

FIG. 13 is a plan view of a fifth conductive layer according to an embodiment of the present disclosure;

FIG. 14 is a circuit diagram of an 8T2C gate driving circuit according to an embodiment of the present disclosure;

FIG. 15 is a timing diagram illustrating an operation of the 8T2C gate driving circuit shown in FIG. 14;

FIG. 16 is a plan view of a semiconductor layer and a third conductive layer stacked together according to an embodiment of the present disclosure; and

FIG. 17 is a plan view of a semiconductor layer, a third conductive layer, a fourth conductive layer, and a fifth conductive layer stacked together according to an embodiment of the present disclosure.

Reference numbers: GOA, gate driving unit; CK, first clock signal terminal; CB, second clock signal terminal; M1, first conductive layer; M2, second conductive layer; VGL, first power supply line; VGH, second power supply line; GSTV, input signal line; VL, first voltage signal; VH, second voltage signal; VSS, third power supply line; VSS1, first conductive portion; VSS2, second conductive portion; VSS3, third conductive section; V1, first connecting via; V2, second connecting via; H, opening; X, first direction; Y, second direction; 01, semiconductor layer; M3, third conductive layer; M4, fourth conductive layer; M5, fifth conductive layer; C1, first capacitor; C11, first plate of first capacitor; C12, second plate of first capacitor; C2, second capacitor; C21, first plate of second capacitor; C22, second plate of second capacitor; 11, input circuit; 12, first control circuit; 13, second control circuit; 14, third control circuit; 15, output control circuit; 16, output circuit; N1, first node; N2, second node; N3, third node; T1, first transistor; T2, second transistor; T3, third transistor; T4, fourth transistor; T5, fifth transistor; T6, sixth transistor; T7, seventh transistor; T8, eighth transistor; STV, input terminal; OUT, output terminal; S1, first adapter electrode; S2, second adapter electrode; S3, third adapter electrode; S4, fourth adapter electrode; and S5, fifth adapter electrode.

### DETAIL DESCRIPTION OF EMBODIMENTS

To make the objects, technical solutions and advantages of the embodiments of the present disclosure more apparent, the technical solutions in the embodiments of the present disclosure will be described clearly and completely with reference to the drawings in the embodiments of the present disclosure. Obviously, the described embodiments are only a few, not all of, embodiments of the present disclosure. Components of the embodiments of the present disclosure, as generally described and illustrated in the drawings, could be arranged and designed in a wide variety of different configurations. Thus, the following detailed description of the embodiments of the present disclosure, provided in the accompanying drawings, is not intended to limit the scope of the present disclosure, as claimed, but is merely representative of selected embodiments of the present disclosure. All other embodiments, which can be derived by one of ordinary skill in the art from the embodiments of the present disclosure without making any inventive effort, shall fall within the protection scope of the present disclosure.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”, “an”, “the”, or the like used herein does not denote a limitation of quantity, but rather denotes the presence of at least one element. The term “comprising”, “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may also be changed accordingly.

The phrase “a plurality of” or “multiple” or “several” used in this disclosure means two or more. The phrase “and/or” describes the association relationship of the associated objects, indicating that there may be three relationships; for example, A and/or B, which may indicate the following three cases: A exists alone, A and B both exist, and B exists alone. The character “/” generally indicates that the preceding and following associated objects are in an “or” relationship.

It should be noted that a drawing process is performed on some layers so that the layers are semitransparent in the drawings, to facilitate the illustration of a positional relationship among all of layers. However, this does not mean that the layers are actually transparent, i.e., materials of the layers are not limited.

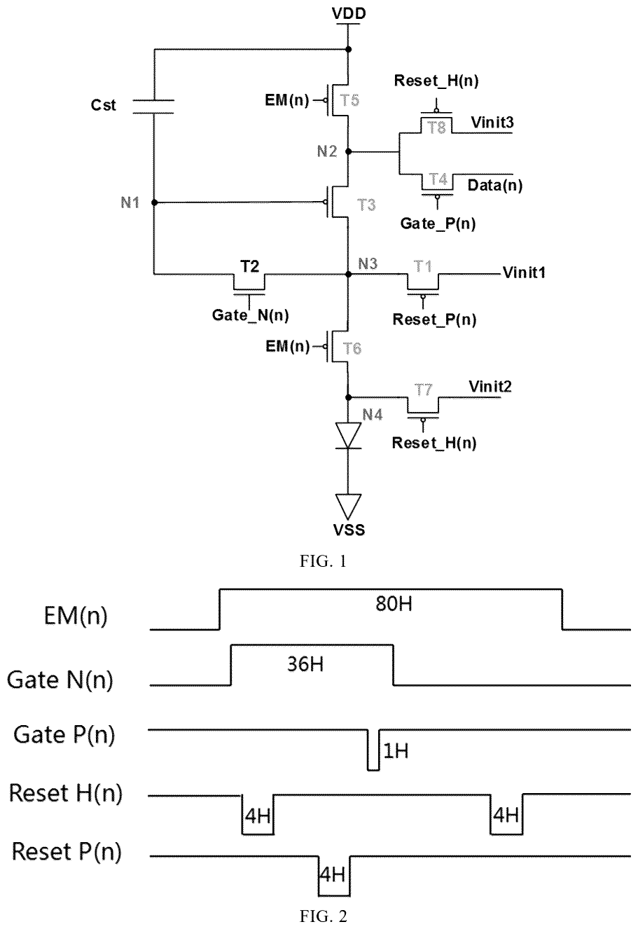

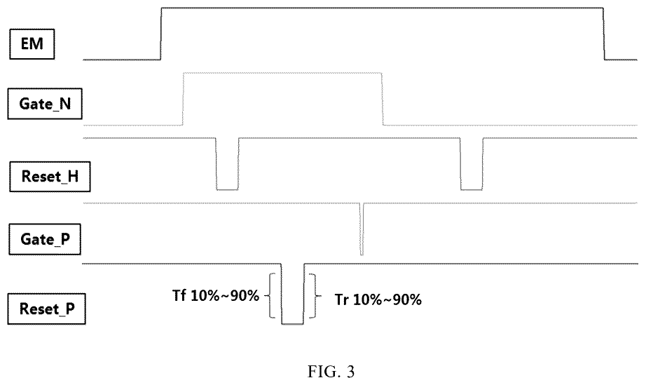

In the related art, a common pixel driving circuit for driving a pixel to emit light is, for example, an 8T1C pixel driving circuit (including 8 transistors and 1 capacitor). FIG. 1 is a schematic diagram of an 8T1C pixel driving circuit in the related art. As shown in FIG. 1, 5 groups of scan driving circuits are required to be in operation together to control EM, GateN, GateP, ResetH, and ResetP terminals, respectively, so as to drive pixels to emit light. It can be seen from this that the scan driving circuits affect the light emitting of the pixels, and particularly, a gate driving circuit (GOA) is directly related to the quality of display pictures. Taking a resolution of 2232 (columns)×3184 (rows) as an example, at a refresh rate of 120 Hz, the time allocated to each row of pixel units in each frame is only 1 s/120 Hz/3184=2.6 us. An ideal output waveform of the pixel driving circuit is shown in FIG. 2, where “H” represents a period of time for which each row of pixel units is driven. Voltage transitions of a first power line VGL and a second power line VGH should ideally occur instantaneously. However, the gate driving circuit has a load RC (R refers to a resistance, and C refers to a capacitance), which causes an actual output waveform as shown in FIG. 3. Actually, the voltage transitions of the first power line VGL and the second power line VGH are slow, and the greater the load (including the R and the C) of the gate driving circuit is, the greater a rising edge Tr and a falling edge Tf of an output waveform of the gate driving circuit are (seriously exceeding 1 us), which excessively occupies the effective operation time outputted to the pixel driving circuit. Since transistors are turned on row by row in the gate driving circuit (by controlling a fourth transistor T4 in the pixel driving circuit to be turned on to write a data voltage signal (Data)), and only one row of pixel units is turned on at a time, the gate driving circuit is most affected by the load, thereby affecting the quality of the display pictures.

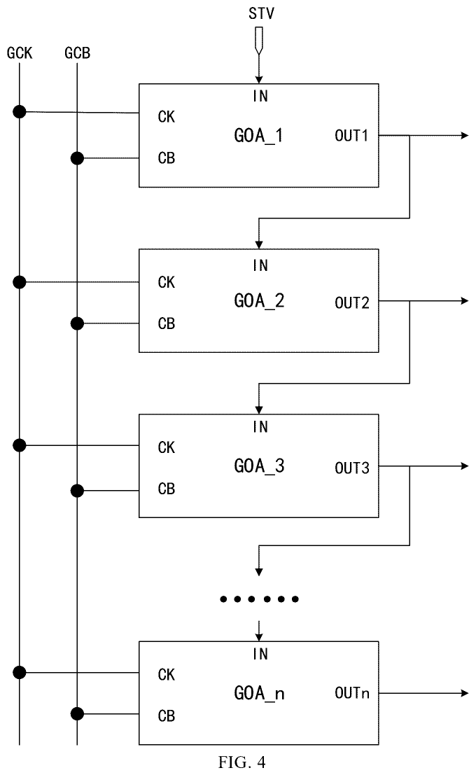

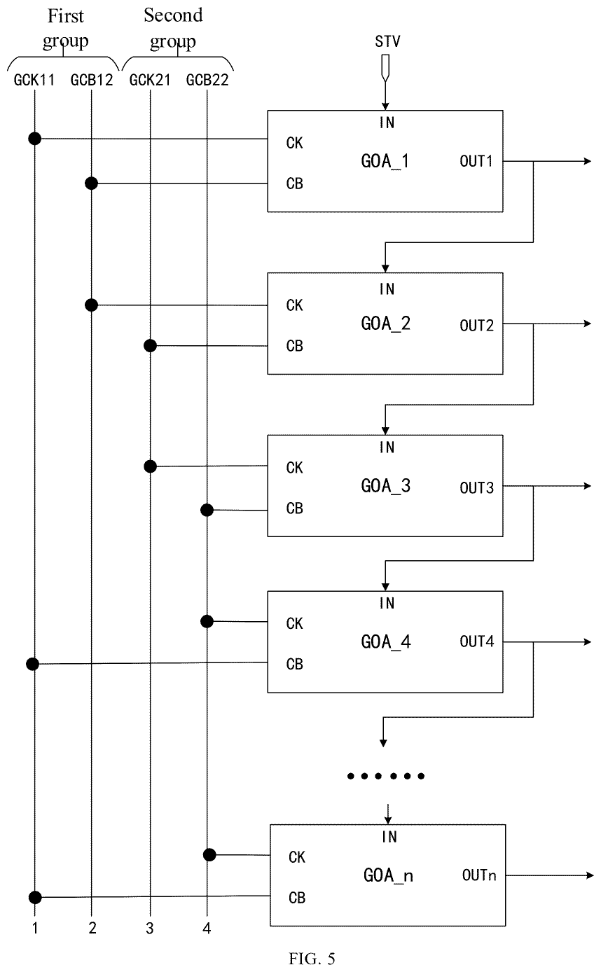

For example, FIG. 4 is a schematic diagram of cascaded gate driving units in the related art. As shown in FIG. 4, the gate driving circuit in the related art includes n cascaded gate driving units GOA, a first clock signal line GCK and a second clock signal line GCB, each gate driving unit GOA includes a first clock signal terminal CK and a second clock signal terminal CB, the first clock signal line GCK is connected to the first clock signal terminal CK of each cascaded gate driving unit GOA, and the second clock signal line GCB is connected to the second clock signal terminal CB of each cascaded gate driving unit GOA. Generally, only two clock signal lines, namely, the first clock signal line GCK connected to the first clock signal terminal CK of each cascaded gate driving unit GOA, and the second clock signal line GCB connected to the second clock signal terminal CB of each cascaded gate driving unit GOA as shown in FIG. 4, are designed for the conventional gate driving circuit. However, the first clock signal terminal CK and the second clock signal terminal CB need to load each cascaded gate driving unit GOA, so that the overall RC is great, and thus the rising edge Tr and the falling edge Tf of the output waveform of the gate driving circuit have great delays, which excessively occupies the effective operation time outputted to the pixel driving circuit and will seriously affects the quality of the display pictures.

In view of this, the present disclosure provides a display substrate, in which a plurality of clock signal lines are provided for a gate driving circuit, and divided into N groups, and each group includes two clock signal lines. For any two adjacent gate driving units in every 2N cascaded gate driving units, a first clock signal terminal of an ith gate driving unit is connected to an ith clock signal line, a second clock signal terminal of the ith gate driving unit is connected to an (i+1)th clock signal line, and a timing sequence of the ith clock signal line is opposite to that of the (i+1)th clock signal line. A first clock signal terminal of a 2N-th gate driving unit is connected to a 2N-th clock signal line, a second clock signal terminal of the 2N-th gate driving unit is connected to a first clock signal line, and a timing sequence of the 2N-th clock signal line is opposite to that of the first clock signal line. The clock signal lines connected to the first clock signal terminals are different from each other, and the clock signal lines connected to the second clock signal terminals are different from each other. Therefore, the load on each clock signal line is reduced, the effective operation time to the pixel driving circuit occupied by the gate driving circuit is shortened, and the uniformity of the large-screen display image quality is improved.

A specific structure of a display substrate provided in an embodiment of the present disclosure will be described in detail below.

FIG. 5 is a schematic diagram of a structure of a display substrate according to an embodiment of the present disclosure. As shown in FIG. 5, the display substrate includes a base substrate, and a gate driving circuit and a plurality of clock signal lines disposed on the base substrate, the gate driving circuit includes a plurality of cascaded gate driving units GOA, the plurality of clock signal lines are divided into N groups, and each group includes two clock signal lines, N is a positive integer greater than or equal to 2. FIG. 5 illustrates an example of N=2, other cases for values of N are not listed here.

For any two adjacent gate driving units GOA in every 2N cascaded gate driving units GOA, a first clock signal terminal CK of an ith gate driving unit GOA_i is connected to an ith clock signal line, a second clock signal terminal CB of the ith gate driving unit GOA_i is connected to an (i+1)th clock signal line, wherein i is a positive integer in a range from 1 to (2N−1), the clock signal lines connected to the first clock signal terminals CK are different from each other, the clock signal lines connected to the second clock signal terminals CB are different from each other, and a timing sequence of the ith clock signal line is opposite to that of the (i+1)th clock signal line. A first clock signal terminal CK of a 2N-th gate driving unit GOA_2N is connected to a 2N-th clock signal line, a second clock signal terminal CB of the 2N-th gate driving unit GOA_2N is connected to a first clock signal line, and a timing sequence of the 2N-th clock signal line is opposite to that of the first clock signal line.

For example, as shown in FIG. 5, for every adjacent gate driving units GOA in every four cascaded gate driving units GOA, a first clock signal terminal CK of a first gate driving unit GOA_1 is connected to a first clock signal line, i.e., a first clock signal line GCK11 in a first group. A second clock signal terminal CB of the first gate driving unit GOA 1 is connected to a second clock signal line, i.e., a second clock signal line GCB12 in the first group. A timing sequence of the first clock signal line is opposite to that of the second clock signal line, that is, a timing sequence of the first clock signal line GCK11 in the first group is opposite to that of the second clock signal line GCB12 in the first group. A first clock signal terminal CK of a second gate driving unit GOA_2 is connected to the second clock signal line, i.e., the second clock signal line GCB12 in the first group. A second clock signal terminal CB of the second gate driving unit GOA_2 is connected to a third clock signal line, i.e., a first clock signal line GCK21 in the second group. A timing sequence of the second clock signal line is opposite to that of the third clock signal line, that is, a timing sequence of the second clock signal line GCB12 in the first group is opposite to that of the first clock signal line GCK21 in the second group. A first clock signal terminal CK of a third gate driving unit GOA_3 is connected to the third clock signal line, i.e., the first clock signal line GCK21 in the second group. A second clock signal terminal CB of the third gate driving unit GOA_3 is connected to a fourth clock signal line, i.e., a second clock signal line GCB22 in the second group. A timing sequence of the third clock signal line is opposite to that of the fourth clock signal line, that is, a timing sequence of the first clock signal line GCK21 in the second group is opposite to that of the second clock signal line GCB22 in the second group. A first clock signal terminal CK of a fourth gate driving unit GOA_4 is connected to a fourth clock signal line, i.e., a second clock signal line GCB22 in the second group. A second clock signal terminal CB of the fourth gate driving unit GOA_4 is connected to the first clock signal line, i.e., the first clock signal line GCK11 in the first group. A timing sequence of the fourth clock signal line is opposite to that of the first clock signal line, that is, a timing sequence of the second clock signal line GCB22 in the second group is opposite to that of the first clock signal line GCK11 in the first group.

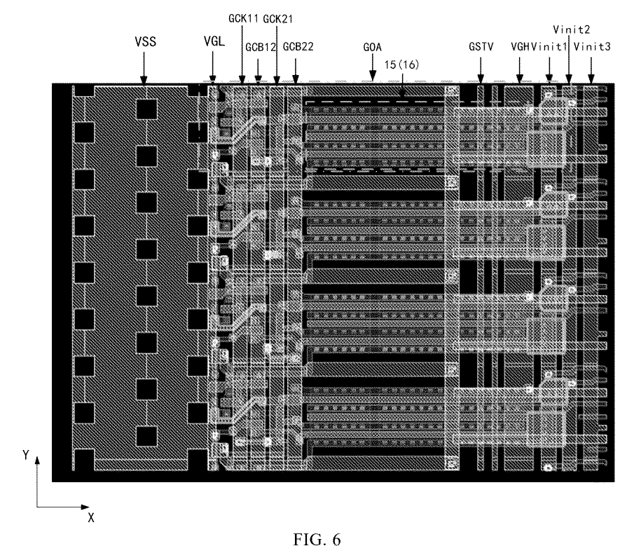

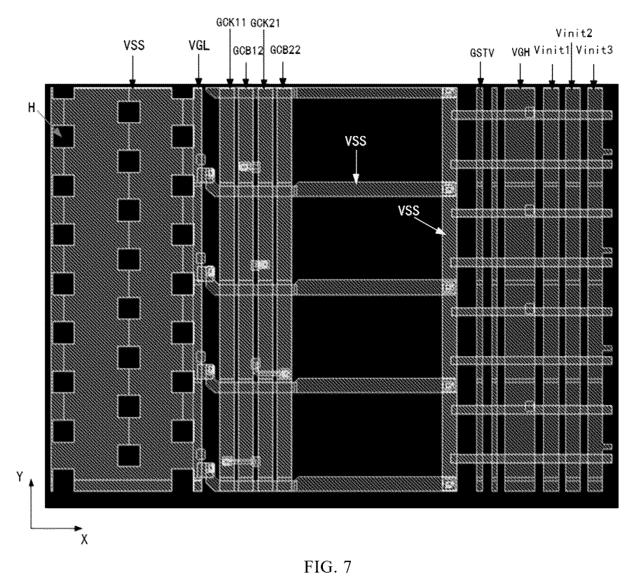

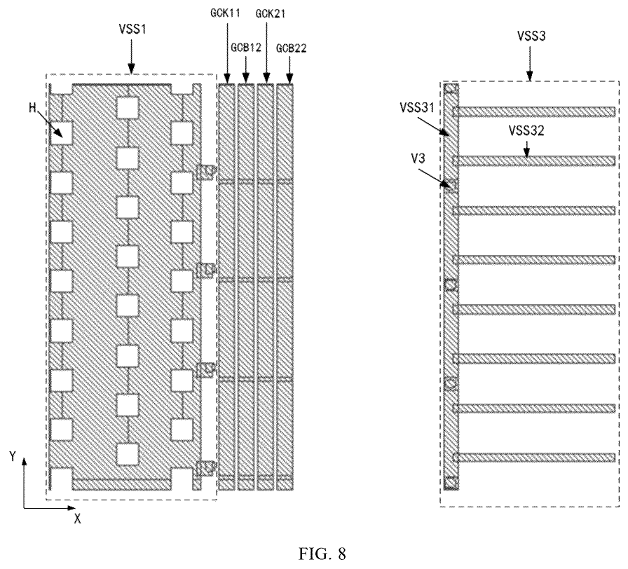

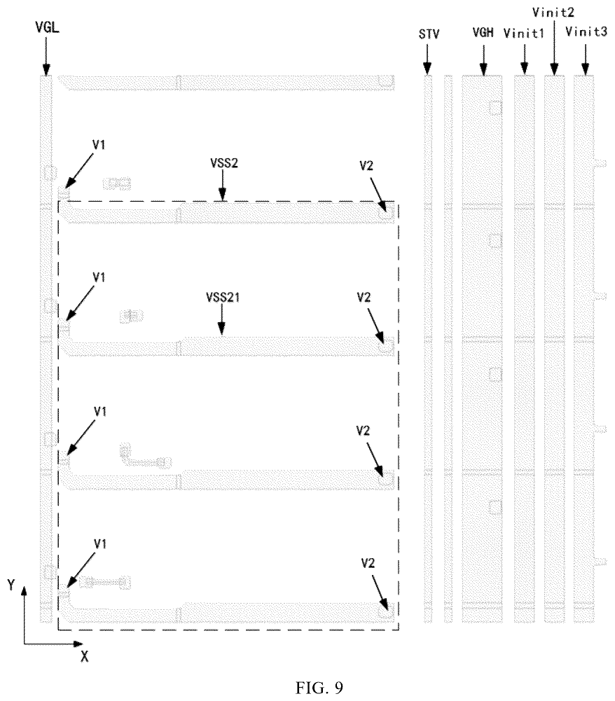

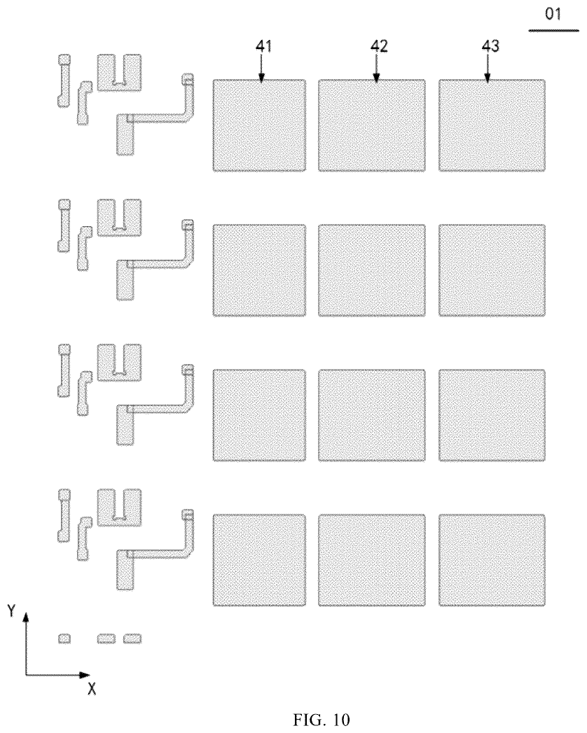

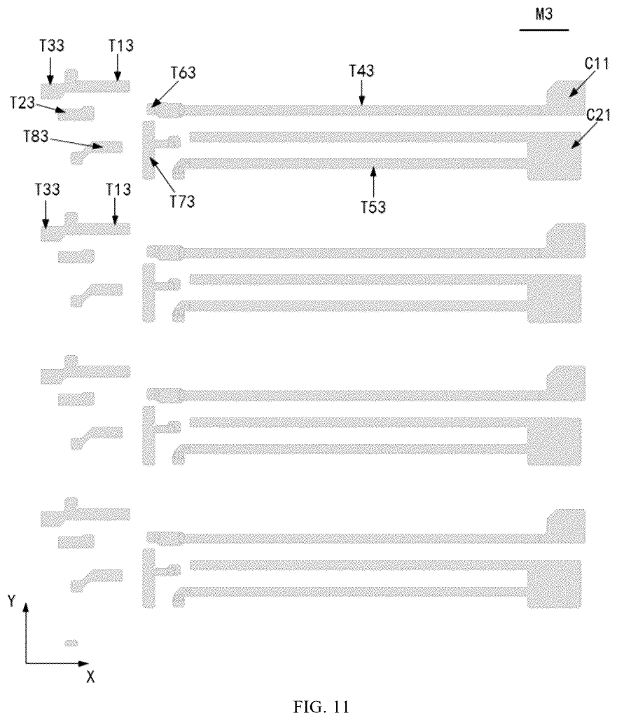

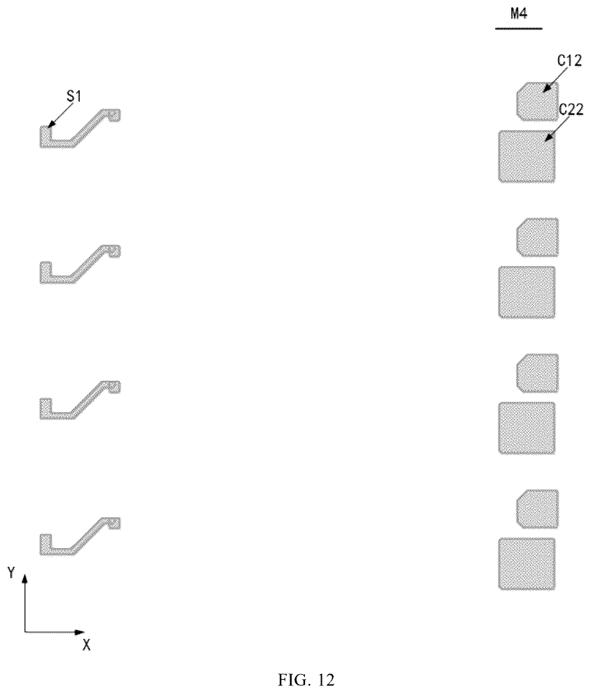

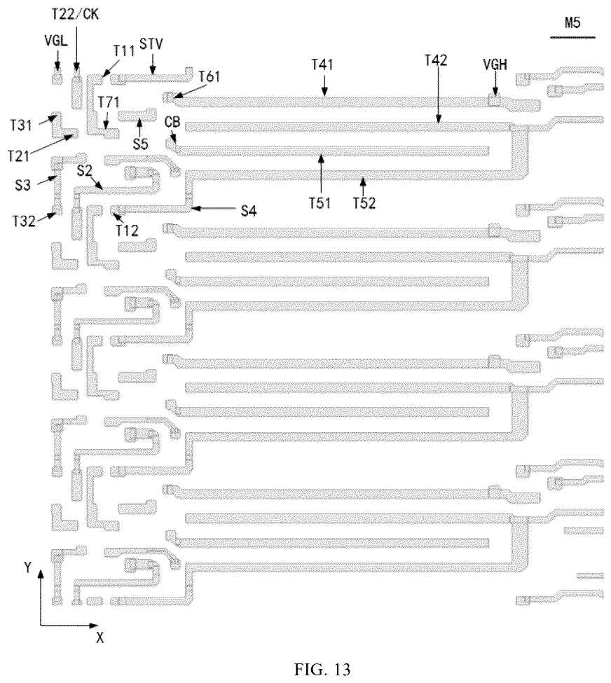

FIG. 6 is a plan view of stacked layers of a gate driving circuit according to an embodiment of the present disclosure; FIG. 7 is a plan view of a first conductive layer M1 and a second conductive layer M2 stacked as according to an embodiment of the present disclosure; FIG. 8 is a plan view of a first conductive layer M1 according to an embodiment of the present disclosure; FIG. 9 is a plan view of a second conductive layer M2 according to an embodiment of the present disclosure; FIG. 10 is a plan view of a semiconductor layer according to an embodiment of the present disclosure; FIG. 11 is a plan view of a third conductive layer M3 according to an embodiment of the present disclosure; FIG. 12 is a plan view of a fourth conductive layer M4 according to an embodiment of the present disclosure; FIG. 13 is a plan view of a fifth conductive layer M5 according to an embodiment of the present disclosure.

For example, the display substrate includes a display region and a non-display region. The gate driving circuit is located in the non-display region.

In some embodiments, as shown in FIG. 6, the plurality of cascaded gate driving units GOA are arranged side by side along the second direction Y.

As shown in FIGS. 6 and 7, any one of the clock signal lines extends along the second direction Y, and an orthographic projection of each of the clock signal lines in any one group on the base substrate overlaps with an orthographic projection of each gate driving unit GOA on the base substrate.

In the embodiment, the orthographic projection of each clock signal line on the base substrate overlaps with the orthographic projection of each gate driving unit GOA on the base substrate, so that a space occupied by the non-display region can be reduced, and the narrow border is favorably realized.

In some embodiments, as shown in FIGS. 6 and 8, the display substrate further includes a driving circuit layer disposed on the base substrate, a first conductive layer M1 disposed on a side of the driving circuit layer away from the base substrate, and each clock signal line is located in the first conductive layer M1.

As shown in FIGS. 6, 7, and 8, taking two groups of clock signal lines as an example, the clock signal lines include the first clock signal line GCK11 in the first group, the second clock signal line GCB12 in the first group, the first clock signal line GCK21 in the second group, and the second clock signal line GCB22 in the second group.

In some embodiments, as shown in FIGS. 6, 7 and 9, the display substrate further includes a second conductive layer M2 between the first conductive layer M1 and the driving circuit layer. The display substrate further includes a first power line VGL configured to transmit a first voltage signal VL to the gate driving circuit, a second power line VGH configured to transmit a second voltage signal VH to the gate driving circuit, and an input signal line GSTV configured to supply an input signal to the gate driving circuit. The first power line VGL, the second power line VGH, and the input signal line GSTV are all located in the second conductive layer M2.

Signal lines are generally arranged in the same layer in the related art. For example, clock signal lines are located in the second conductive layer M2 together with other power lines and the input signal line GSTV. The clock signal lines are arranged in the first conductive layer M1 in the present disclosure, and are in different layers from other power lines and the input signal line GSTV. An area occupied by the non-display region is reduced compared with the related art. In addition, the first conductive layer M1 and the driving circuit layer are separated from each other by two insulating layers therebetween, so that a parasitic capacitance of each clock signal line in the first conductive layer M1 can be effectively reduced, the load on each clock signal line is reduced, and the uniformity of the large-screen display image quality is improved.

In some embodiments, as shown in FIGS. 8 and 9, the display substrate further includes a light emitting device (not shown) and a third power line VSS, the third power line VSS is connected to the light emitting device and includes a first conductive portion VSS1, a second conductive portion VSS2, and a third conductive portion VSS3 connecting the first conductive portion VSS1 and the second conductive portion VSS2, and the first conductive portion VSS1 and the third conductive portion VSS3 are both located in the first conductive layer M1. The display substrate further includes a second conductive layer M2 located between the first conductive layer M1 and the driving circuit layer, the second conductive portion VSS2 is located in the second conductive layer M2 and is connected to the first conductive portion VSS1 through a first connecting via V1, and the second conductive portion VSS2 is connected to the third conductive portion VSS3 through a second connecting via V2.

In some embodiments, as shown in FIG. 9, the display substrate includes the display region and the non-display region. The first power line VGL, the second power line VGH, the second conductive portion VSS2 and the input signal line GSTV are all located in the non-display region, the first power line VGL is located on a side of the second conductive portion VSS2 away from the display region, the second power line VGH is located on a side of the second conductive portion VSS2 close to the display region, and the input signal line GSTV is located between the second power line VGH and the second conductive section VSS2.

In some embodiments, as shown in FIGS. 7, 8, and 9, the second conductive portion VSS2 includes a first end, a second end, and main portions VSS21 connected between the first end and the second end, and orthographic projections of the main portions VSS21 on the base substrate is located between an orthographic projection of the first conductive portion VSS1 on the base substrate and an orthographic projection of the third conductive portion VSS3 on the base substrate.

For example, the main portions VSS21 of the second conductive portion VSS2 extend in the first direction X. The first end of the second conductive portion VSS2 is connected to the first conductive portion VSS1 through the first connecting via V1. The second end of the second conductive portion VSS2 is connected to the third conductive portion VSS3 through the second connecting via V2.

For example, the third conductive portion VSS3 includes a first end VSS31 and a second end (not shown), and main portions VSS32 connected between the first end VSS31 and the second end. The main portion sVSS32 of the third conductive portion VSS3 extend in the first direction X. The first end VSS31 of the third conductive portion VSS3 is connected to the second end of the second conductive portion VSS2 through a third connecting via V3. The second end of the third conductive portion VSS3 is electrically connected to a second electrode (e.g., a cathode) of the light emitting device.

For example, the main portions VSS32 of the third conductive portion VSS3 are arranged side by side along the second direction Y and extend to the display region along the first direction X, and are distributed in a mesh shape in the display region to reduce a voltage across the third power line VSS.

The third power line VSS of the present disclosure is designed to include the portions in different layers connected together, which provides the space for the routing of the clock signal lines in the first conductive layer M1.

In some embodiments, as shown in FIG. 6, the gate driving unit GOA includes an output circuit 16 and an output control circuit 15. The orthographic projections of the main portions VSS21 on the base substrate do not overlap with orthographic projections of the output circuit 16 and the output control circuit 15 in the gate driving circuit on the base substrate, thereby avoiding the influence of the third power line VSS on transistors in the output circuit 16 and the output control circuit 15 of the gate driving unit GOA.

In some embodiments, a planarization layer is disposed between the first conductive layer M1 and the second conductive layer M2, the first connecting via V1 and the second connecting via V2 penetrate through the planarization layer, respectively, and a thickness of the planarization layer is between 1.5 μm and 2.0 μm, so that the parasitic capacitance of the clock signal lines can be effectively reduced.

In some embodiments, as shown in FIG. 6 and FIGS. 10 to 13, the driving circuit layer includes a semiconductor layer 01, a third conductive layer M3, a fourth conductive layer M4, and a fifth conductive layer M5, which are sequentially disposed on the base substrate, an active layer of each transistor in the gate driving circuit is located in the semiconductor layer 01, a control electrode of each transistor, a first plate C11 of a first capacitor C1, and a first plate C21 of a second capacitor C2 in the gate driving circuit are all located in the third conductive layer M3, a second plate C12 of the first capacitor C1 and a second plate C22 of the second capacitor C2 in the gate driving circuit are both located in the fourth conductive layer M4, and a first electrode and a second electrode of each transistor in the gate driving circuit are located in the fifth conductive layer M5.

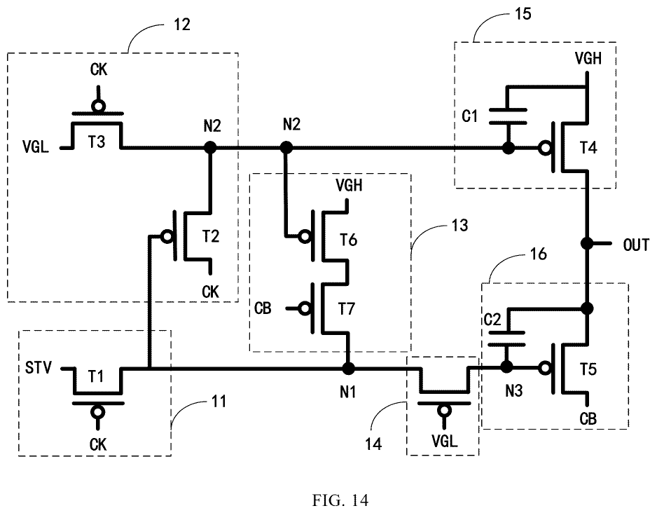

In some embodiments, as shown in FIG. 14, each gate driving unit GOA includes an input circuit 11, a first control circuit 12, a second control circuit 13, a third control circuit 14, an output control circuit 15, and an output circuit 16. The input circuit 11 is configured to input the input signal transmitted by the input signal line GSTV to a first node N1 in response to receiving a first clock signal from the first clock signal terminal CK, the first control circuit 12 is configured to control a level at a second node N2 in response to a first voltage signal VL transmitted by the first power line VGL, a level at the first node N1, and the first clock signal, the second control circuit 13 is configured to control the level at the first node N1 in response to the level at the second node N2, a second clock signal from the second clock signal terminal CB, and a second voltage signal VH transmitted by the second power line VGH, the third control circuit 14 is configured to control a level at a third node N3 in response to the level at the first node N1 and the second clock signal from the second clock signal terminal CB, the output control circuit 15 is configured to control a level at an output terminal OUT in response to the level at the second node N2 and the second voltage signal VH, and the output circuit 16 is configured to output the second clock signal from the second clock signal terminal CB to the output terminal OUT in response to the level at the third node N3.

For example, each gate driving unit GOA in the embodiment of the present disclosure may be an 8T2C circuit (including 8 transistors and 2 capacitors). FIG. 14 is a circuit diagram of an 8T2C gate driving circuit according to an embodiment of the present disclosure. As shown in FIG. 14, the input circuit 11 includes a first transistor T1, a control electrode of the first transistor T1 is connected to the first clock signal terminal CK, a second electrode of the first transistor T1 is connected to an input terminal STV, and a first electrode of the first transistor T1 is connected to the first node N1. The first control circuit 12 includes a second transistor T2 and a third transistor T3, a control electrode of the second transistor T2 is connected to the first node N1, a second electrode of the second transistor T2 is connected to the first clock signal terminal CK (and in turn to the first clock signal line), a first electrode of the second transistor T2 is connected to the second node N2, a control electrode of the third transistor T3 is connected to the first clock signal terminal CK (and in turn to the first clock signal line), a second electrode of the third transistor T3 is connected to a first power terminal (and in turn to the first power line VGL), and a first electrode of the third transistor T3 is connected to the second node N2. The second control circuit 13 includes a sixth transistor T6 and a seventh transistor T7, a control electrode of the sixth transistor T6 is connected to the second node N2, a first electrode of the sixth transistor T6 is connected to a second power terminal (and in turn to the second power line VGH), a second electrode of the sixth transistor T6 is connected to a second electrode of the seventh transistor T7, a control electrode of the seventh transistor T7 is connected to the second clock signal terminal CB (and in turn to the second clock signal line), and a first electrode of the seventh transistor T7 is connected to the first node N1. The third control circuit 14 includes an eighth transistor T8, a control electrode of the eighth transistor T8 is connected to the first power terminal (and in turn to the first power line VGL), a second electrode of the eighth transistor T8 is connected to the first node N1, and a first electrode of the eighth transistor T8 is connected to the third node N3. The output control circuit 15 includes a fourth transistor T4 and a first capacitor C1, a control electrode of the fourth transistor T4 is connected to the second node N2, a first electrode of the fourth transistor T4 is connected to the second power terminal (and in turn to the second power line VGH), a second electrode of the fourth transistor T4 is connected to the output terminal OUT (and in turn to a fourth adapter electrode), a first plate C11 of the first capacitor C1 is connected to the second node N2, and a second plate C12 of the first capacitor C1 is connected to the second power terminal (and in turn to the second power line VGH). The output circuit 16 includes a fifth transistor T5 and a second capacitor C2, a control electrode of the fifth transistor T5 is connected to the third node N3, a first electrode of the fifth transistor T5 is connected to the second clock signal terminal CB (and in turn to the second clock signal line), a second electrode of the fifth transistor T5 is connected to the output terminal OUT (and in turn to the fourth adapter electrode), a first plate C21 of the second capacitor C2 is connected to the third node N3, and a second plate C22 of the second capacitor C2 is connected to the output terminal OUT (and in turn to the fourth adapter electrode).

It should be noted that each of the first transistor T1 to the eighth transistor T8 is a P-type transistor as an example, and is turned on (at a turned-on level) when the gate electrode of each transistor is input with a signal having a low level and is turned off (at a turned-off level) when the gate electrode is input with a signal having a high level. In this case, the first electrode of each transistor may be a source electrode, the second electrode of each transistor may be a drain electrode, and the control electrode of each transistor is a gate electrode.

Alternatively, each gate driving unit GOA in the embodiment of the present disclosure is not limited to the 8T2C circuit, and other circuits may be used for the gate driving unit GOA.

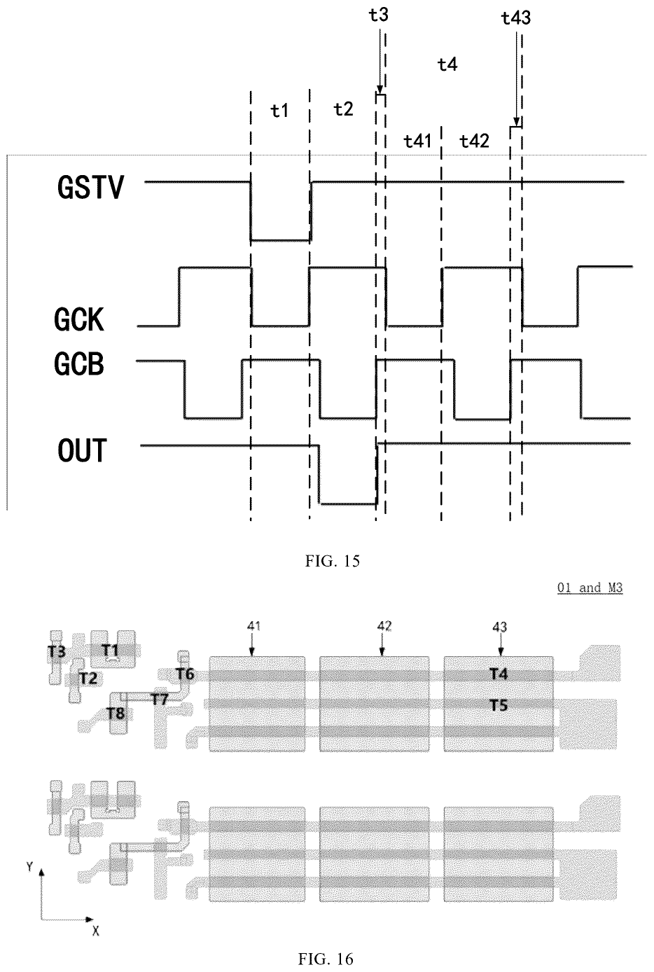

For example, FIG. 15 is a timing diagram illustrating an operation of the 8T2C gate driving circuit shown in FIG. 14. As shown in FIG. 15, an operation principle of the gate driving circuit is as follows:

In an input phase t1, the first clock signal provided on the first clock signal line GCK is a low level signal (a signal having a low level), the second clock signal provided on the second clock signal line GCB is a high level signal (a signal having a high level), and the input signal provided on the input signal line GSTV is a low level signal. For example, the input signal is equal to the first voltage signal VL. The first clock signal is a low level signal, so that the first transistor T1 is turned on, and the input signal is transmitted to the first node N1 through the first transistor T1. Since the first transistor T1 has a threshold loss in transmitting the low level signal, a voltage at the first node N1 is Vin−Vth1, i.e., VL−Vth1, where Vin represents a voltage of the input signal and Vth1 represents a threshold voltage of the first transistor T1. Since the gate electrode of the eighth transistor T8 receives the first voltage signal VL and thus the eighth transistor T8 is in a turned-on state, the voltage VL−Vth1 at the first node N1 is transmitted to the third node N3 through the eighth transistor T8. For example, a threshold voltage of the eighth transistor T8 is denoted as Vth8. Similarly, since the eighth transistor T8 has a threshold loss in transmitting the low level signal, a voltage at the third node N3 is VL−VthN3, where VthN3 is the smaller one of Vth1 and Vth8. The voltage at the third node N3 may control the fifth transistor T5 to be turned on, and the second clock signal is written into the output terminal OUT through the fifth transistor T5 as an output signal. That is, in the input phase t1, the output signal is the second clock signal having a high level, i.e., the second voltage signal VH.

In the input phase t1, the first clock signal is a low level signal, so that the third transistor T3 is turned on, and the first voltage signal VL is transmitted to the second node N2 through the third transistor T3. The voltage at the first node N1 is VL−Vth2, so that the second transistor T2 is turned on, and the first clock signal having the low level is transmitted to the second node N2 through the second transistor T2. For example, a threshold voltage of the second transistor T2 is denoted as Vth2, and a threshold voltage of the third transistor T3 is denoted as Vth3. When Vth3<Vth2+Vth1, the voltage at the second node N2 is VL−Vth2−Vth1. When Vth3>Vth2+Vth1, the voltage at the second node N2 is VL−Vth3. At this time, both the fourth transistor T4 and the sixth transistor T6 are turned on. Since the second clock signal is a high level signal, the seventh transistor T7 is turned off.

In an output phase t2, the first clock signal provided on the first clock signal line GCK is a high level signal, the second clock signal provided on the second clock signal line GCB is a low level signal, and the input signal provided on the input signal line GSTV is a high level signal. The fifth transistor T5 is turned on, and the second clock signal is written to the output terminal OUT as an output signal through the fifth transistor T5. In the input phase t1, a voltage of the second plate C22 of the second capacitor C2 connected to the output terminal OUT is the second voltage signal VH, and a voltage of the first plate C21 of the second capacitor C2 connected to the third node N3 is VL−VthN3. In the output phase t2, the voltage of the second plate C22 of the second capacitor C2 connected to the output terminal OUT becomes VL, and due to the bootstrapping effect of the second capacitor C2, the voltage of the first plate C21 of the second capacitor C2 connected to the third node N3 is 2VL−VthN3−VH, that is, the voltage at the third node N3 becomes 2VL−VthN3−VH. At this time, the eighth transistor T8 is turned off, the fifth transistor T5 can be turned on better, and the output signal is the first voltage signal VL.

In the output phase t2, the first clock signal is a high level signal, so that both the first transistor T1 and the third transistor T3 are turned off. The voltage at the first node N1 is still VL−VthN3, so that the second transistor T2 is turned on, and the first clock signal having the high level is transmitted to the second node N2 through the second transistor T2, that is, the voltage at the second node N2 is the second voltage signal VH. Thus, both the fourth transistor T4 and the sixth transistor T6 are turned off. The second clock signal is a low level signal, so that the seventh transistor T7 is turned on.

In a buffering phase t3, the first clock signal provided on the first clock signal line GCK and the second clock signal provided on the second clock signal line GCB are both high level signals, and the input signal provided on the input signal line GSTV is a high level signal. The fifth transistor T5 is turned on, and the second clock signal is written to the output terminal OUT as an output signal through the fifth transistor T5. At this time, the output signal is the second clock signal with a high level, that is, the second voltage signal VH. The voltage at the third node N3 becomes VL−VthN3 due to the bootstrapping effect of the second capacitor C2.

In the buffering phase t3, the first clock signal is a high level signal, so that both the first transistor T1 and the third transistor T3 are turned off. The voltage at the third node N3 becomes VL−VthN3. At this time, the eighth transistor T8 is turned on, and the voltage at the first node N1 is also VL−VthN3, so that the second transistor T2 is turned on, and the first clock signal having the high level is transmitted to the second node N2 through the second transistor T2, that is, the voltage at the second node N2 is the second voltage signal VH. Thus, both the fourth transistor T4 and the sixth transistor T6 are turned off. Since the second clock signal is a high level signal, the seventh transistor T7 is turned off.

In a first sub-phase t41 of a stable phase t4, the first clock signal provided on the first clock signal line GCK is a low level signal, the second clock signal provided on the second clock signal line GCB is a high level signal, and the input signal provided on the input signal line GSTV is a high level signal. For example, the input signal is equal to the second voltage signal VH. Since the first clock signal is a low level signal, the first transistor T1 is turned on, and the input signal is transmitted to the first node N1 through the first transistor T1. Since the first transistor T1 has a threshold loss in transmitting the low level signal, the voltage at the first node N1 is Vin, i.e., the second voltage signal VH, and the second transistor T2 is turned off. Since the eighth transistor T8 is in a turned-on state, the voltage at the third node N3 is the same as that at the first node N1, that is, the voltage at the third node N3 is VH, and the fifth transistor T5 is turned off. Since the first clock signal is a low level signal, the third transistor T3 is turned on, and the voltage at the second node N2 is VL−Vth3. Therefore, the fourth transistor T4 and the sixth transistor T6 are both turned on, and the second voltage signal VH is transmitted to the output terminal OUT through the fourth transistor T4, that is, the output signal is the second voltage signal VH.

In a second sub-phase t42 of the stable phase t4, the first clock signal provided on the first clock signal line GCK is a high level signal, the second clock signal provided on the second clock signal line GCB is a low level signal, and the input signal provided on the input signal line GSTV is a high level signal. The voltage at each of the third node N3 and the first node N1 is Vin (i.e., the second voltage signal VH), and both the fifth transistor T5 and the second transistor T2 are turned off. The first clock signal is a high level signal, so that the first transistor T1 and the third transistor T3 are both turned off. The voltage at the second node N2 is still VL−Vth3 due to the holding effect of the first capacitor C1, so that the fourth transistor T4 and the sixth transistor T6 are both turned on, the second voltage signal VH is transmitted to the output terminal OUT through the fourth transistor T4, and the output signal is the second voltage signal VH.

In the second sub-phase t42, since the second clock signal is a low level signal, the seventh transistor T7 is turned on, and thus the second voltage signal VH is transmitted to the first node N1 and the third node N3 through the sixth transistor T6 and the seventh transistor T7, so that the voltage at the third node N3 and the voltage at the first node N1 are maintained at a high level.

In a third sub-phase t43 of the stable phase t4, the first clock signal provided on the first clock signal line GCK and the second clock signal provided on the second clock signal line GCB are both high level signals, and the input signal provided on the input signal line GSTV is a high level signal. The voltage at each of the third node N3 and the first node N1 is VH, so that the fifth transistor T5 and the second transistor T2 are turned off. The first clock signal is a high level signal, so that the first transistor T1 and the third transistor T3 are both turned off, the voltage at the second node N2 is still VL−Vth3, and therefore, the fourth transistor T4 and the sixth transistor T6 are both turned on. The second voltage signal VH is transmitted to the output terminal OUT through the fourth transistor T4, and the output signal is the second voltage signal VH.

For example, as shown in FIG. 5, the first clock signal terminal CK of the ith gate driving unit GOA is connected to the ith clock signal line, and the second clock signal terminal CB of the ith gate driving unit GOA is connected to the (i+1)th clock signal line. That is, the second clock signal terminal CB of the ith gate driving unit GOA and the first clock signal terminal CK of the (i+1)th gate driving unit GOA are commonly connected to the same clock signal line. According to the operation timing of the clock signal lines (the first clock signal line GCK and the second clock signal line GCB) as shown in FIG. 15, as an example, a second clock signal terminal CB of a gate driving unit GOA of a first stage and a first clock signal terminal CK of a gate driving unit GOA of a second stage are connected to a second clock signal line (i.e., the second clock signal line GCB12). The second clock signal line GCB12 provides the second clock signal to the gate driving unit GOA of the first stage as a high level signal in the input phase t1. In the next phase, i.e., the output phase t2, the second clock signal provided by the second clock signal line GCB12 to the gate driving unit GOA of the first stage is a low level signal, and the first clock signal provided to the gate driving unit GOA of the second stage is a low level signal, so that the gate driving unit GOA of the second stage enters the input phase t1.

In this embodiment, the second clock signal terminal CB of the ith gate driving unit GOA_i and the first clock signal terminal CK of the (i+1)th gate driving unit GOA_i+1 are commonly connected to the same clock signal line, to ensure that the gate driving unit GOA of the next stage enters the normal operation timing with the timing principle of the clock signal lines, and to reduce the load of the clock signal lines while the whole routing space of the clock signal lines is reduced.

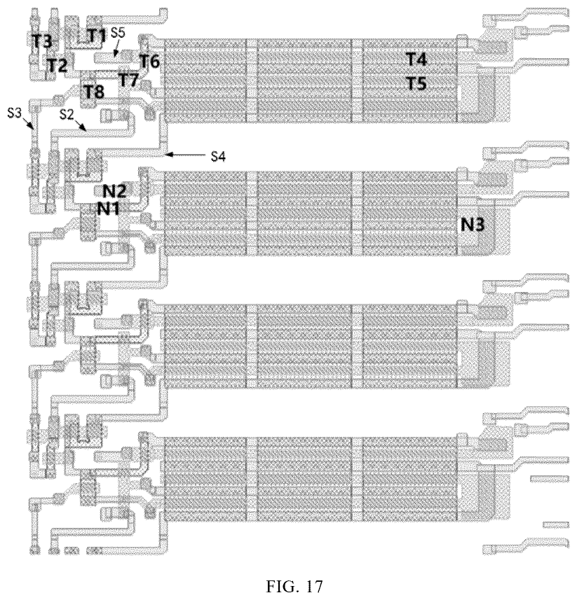

FIG. 16 is a plan view of a semiconductor layer 01 and a third conductive layer M3 stacked according to an embodiment of the present disclosure; and FIG. 17 is a plan view of a semiconductor layer 01, a third conductive layer M3, a fourth conductive layer M4, and a fifth conductive layer M5 stacked according to an embodiment of the present disclosure.

In some embodiments, as shown in FIGS. 6, 11, 12, 13, and 17, the fourth conductive layer M4 further includes a first adapter electrode S1 for connecting the control electrode T63 of the sixth transistor T6 and the first electrode T21 of the second transistor T2. Specifically, the fifth conductive layer M5 further includes a fifth adapter electrode S5, one end of the fifth adapter electrode S5 is connected to the control electrode T63 of the sixth transistor T6, the other end of the fifth adapter electrode S5 is connected to one end of the first adapter electrode S1, and the other end of the first adapter electrode S1 is connected to the first electrode T21 of the second transistor T2.

In some embodiments, as shown in FIGS. 11, 13, 16 and 17, the control electrode T33 of the third transistor T3 and the control electrode T13 of the first transistor T1 are connected together to have a one-piece structure, which is connected to the second electrode T22 of the second transistor T2, and the second electrode T22 of the second transistor T2 is further used as the first clock signal terminal CK of the gate driving unit GOA.

In some embodiments, as shown in FIGS. 11, 13, 16 and 17, the fifth conductive layer M5 further includes a second adapter electrode S2, the second adapter electrode S2 is further used as the second clock signal terminal CB of the ith gate driving unit GOA_i and the first clock signal terminal CK of the (i+1)th gate driving unit GOA_i+1, and is connected to the control electrode T73 of the seventh transistor T7 of the ith gate driving unit GOA_i, the control electrode T13 of the first transistor T1 and the control electrode T33 of the third transistor T3 of the (i+1)th gate driving unit GOA_i+1.

In this embodiment, the control electrode T73 of the seventh transistor T7 of the ith gate driving unit GOA_i and the control electrode T13 of the first transistor T1 of the (i+1)th gate driving unit GOA_i+1 are connected to the clock signal line through the same via, so as to save the space of the gate driving circuit.

No new mask is provided in the embodiment of the present disclosure, so that the design of the present disclosure improves the display image quality without increasing the cost.

In some embodiments, as shown in FIGS. 11, 13, 16 and 17, the fifth conductive layer M5 further includes a third adapter electrode S3 connected to the control electrode T83 of the eighth transistor T8 of the ith gate driving unit GOA i and the second electrode T32 of the third transistor T3 of the (i+1)th gate driving unit GOA_i+1.

In this embodiment, the control electrode T83 of the eighth transistor T8 of the ith gate driving unit GOA_i and the second electrode T32 of the third transistor T3 of the (i+1)th gate driving unit GOA_i+1 are connected to each other by the third adapter electrode S3, so that the control electrode T83 of the eighth transistor T8 of the gate driving unit of the previous stage and the second electrode T32 of the third transistor T3 of the gate driving unit of the present stage may be connected to the first power supply line VGL through a same via, thereby saving the space of the gate driving circuit.

In some embodiments, as shown in FIGS. 13, 16 and 17, the fifth conductive layer M5 further includes a fourth adapter electrode S4, the fourth adapter electrode S4 is further used as the output terminal OUT of the ith gate driving unit GOA_i and the input terminal STV of the (i+1)th gate driving unit GOA_i+1, and is connected to the second electrode T52 of the fifth transistor T5 and the second electrode T42 of the fourth transistor T4 of the ith gate driving unit GOA_i, and the second electrode T12 of the first transistor T1 of the (i+1)th gate driving unit GOA_i+1.

In some embodiments, as shown in FIG. 11, the first plate C11 of the first capacitor C1, the control electrode T43 of the fourth transistor T4, and the control electrode T63 of the sixth transistor T6 have a one-piece structure.

In some embodiments, as shown in FIG. 11, the first plate C21 of the second capacitor C2 and the control electrode T53 of the fifth transistor T5 have a one-piece structure.

In some embodiments, as shown in FIG. 13, the first electrode T31 of the third transistor T3 and the first electrode T21 of the second transistor T2 have a one-piece structure.

In some embodiments, as shown in FIG. 13, the first electrode T11 of the first transistor T1 and the first electrode T71 of the seventh transistor T7 have a one-piece structure.

In some embodiments, as shown in FIG. 13, the first electrode T61 of the sixth transistor T6 and the first electrode T41 of the fourth transistor T4 have a one-piece structure, which is further used as the second power terminal (which is in turn connected to the second power line VGH).

In some embodiments, as shown in FIG. 13, the first electrode T51 of the fifth transistor T5 is further used as the second clock signal terminal CB (which is in turn connected to the second clock signal line GCB).

In some embodiments, as shown in FIG. 13, the second electrode T22 of the second transistor T2 is further used as the first clock signal terminal CK (which is in turn connected to the first clock signal line GCK).

In some embodiments, as shown in FIGS. 10, 11 and 16, an active layer of the fourth transistor T4 and an active layer of the fifth transistor T5 are in common, the active layer of the fourth transistor T4 includes a first semiconductor 41, a second semiconductor 42, and a third semiconductor 43 arranged side by side and at intervals in the first direction X, orthographic projections of the first semiconductor 41, the second semiconductor 42 and the third semiconductor 43 on the base substrate overlap with an orthographic projection of the control electrode T43 of the fourth transistor T4 on the base substrate, respectively, and the orthographic projections of the first semiconductor 41, the second semiconductor 42 and the third semiconductor 43 on the base substrate overlap with an orthographic projection of the control electrode T53 of the fifth transistor T5 on the base substrate, respectively.

In this embodiment, the active layer of the fourth transistor T4 and the active layer of the fifth transistor T5 are in common, which facilitates the fabrication. In addition, the active layer is divided into a plurality of semiconductors at intervals, that is, the first semiconductor 41, the second semiconductor 42 and the third semiconductor 43, which is beneficial to isolating static electricity and releasing stress.

In some embodiments, as shown in FIGS. 7 and 8, the first conductive portion VSS1 includes a plurality of openings H penetrating through the first conductive portion VSS1 along a thickness direction of the first conductive portion VSS1, and multiple openings H are arranged side by side along the second direction Y to form a column of openings H. The plurality of columns of openings H are arranged side by side in the first direction X.

The plurality of openings are arranged in the embodiment of the present disclosure, so that moisture in organic layers below the third power line VSS can be released.

In some embodiments, as shown in FIGS. 6, 7 and 9, the display substrate includes the display region and the non-display region, initialization signal lines located in the non-display region and pixel driving circuits located in the display region. The initialization signal lines Vinit1 to Vinit3 are located in the second conductive layer M2 and connected to the pixel driving circuits.

The pixel driving circuit is, for example, an 8T1C low temperature polycrystalline oxide (LTPO) circuit.

The embodiment of the present disclosure further provides a display apparatus, including the display substrate in any one of the above embodiments. The display apparatus may be any product with a display function, such as a mobile phone, a tablet computer, a television, a display, a notebook computer, a digital photo frame, or a vehicle-mounted device or the like. Other essential components of the display apparatus are understood by one of ordinary skill in the art, and are not described herein and should not be used to limit the present disclosure.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. A display substrate, comprising a base substrate, and a gate driving circuit and a plurality of clock signal lines arranged on the base substrate, wherein the gate driving circuit comprises a plurality of cascaded gate driving units;
the plurality of clock signal lines are divided into N groups, and each group comprises two clock signal lines, where N is a positive integer greater than or equal to 2;
for any two adjacent gate driving units in every 2N cascaded gate driving units, a first clock signal terminal of an ith gate driving unit is connected to an ith clock signal line, a second clock signal terminal of the ith gate driving unit is connected to an (i+1)th clock signal line, where i is a positive integer in a range from 1 to (2N−1), the clock signal lines connected to the first clock signal terminals of the two adjacent gate driving units are different from each other, the clock signal lines connected to the second clock signal terminals of the two adjacent gate driving units are different from each other, and a timing sequence of the ith clock signal line is opposite to that of the (i+1)th clock signal line; and
a first clock signal terminal of a 2N-th gate driving unit is connected to a 2N-th clock signal line, a second clock signal terminal of the 2N-th gate driving unit is connected to a first clock signal line, and a timing sequence of the 2N-th clock signal line is opposite to that of the first clock signal line.

2. The display substrate of claim 1, wherein the plurality of cascaded gate driving units are arranged side by side along a second direction; and
any one of the plurality of clock signal lines extends along the second direction, and an orthographic projection of each of the clock signal lines in any one group on the base substrate overlaps with an orthographic projection of each gate driving unit on the base substrate.

3. The display substrate of claim 1, wherein the display substrate further comprises a driving circuit layer on the base substrate, and a first conductive layer on a side of the driving circuit layer away from the base substrate; and
the plurality of clock signal lines are located in the first conductive layer.

4. The display substrate of claim 3, wherein the display substrate further comprises a light emitting device and a third power line, and the third power line is connected to the light emitting device;
the third power line comprises a first conductive portion, a second conductive portion, and a third conductive portion connecting the first conductive portion and the second conductive portion, and the first conductive portion and the third conductive portion are both located in the first conductive layer; and
the display substrate further comprises a second conductive layer located between the first conductive layer and the driving circuit layer, and the second conductive portion is located in the second conductive layer, is connected to the first conductive portion through a first connecting via, and is connected to the third conductive portion through a second connecting via.

5. The display substrate of claim 4, wherein the second conductive portion comprises a first end, a second end, and a main portion connected between the first end and the second end, and an orthographic projection of the main portion on the base substrate is located between an orthographic projection of the first conductive portion on the base substrate and an orthographic projection of the third conductive portion on the base substrate.

6. The display substrate of claim 5, wherein each gate driving unit comprises an output circuit and an output control circuit; and
the orthographic projection of the main portion on the base substrate does not overlap with orthographic projections of the output circuit and the output control circuit in the gate driving circuit on the base substrate.

7. The display substrate of claim 4, wherein the display substrate further comprises a planarization layer between the first conductive layer and the second conductive layer, and the first connecting via and the second connecting via penetrate through the planarization layer, respectively; and
the planarization layer has a thickness between 1.5 μm and 2.0 μm.

8. The display substrate of claim 4, wherein the display substrate further comprises a first power line configured to transmit a first voltage signal to the gate driving circuit, a second power line configured to transmit a second voltage signal to the gate driving circuit, and an input signal line configured to supply an input signal to the gate driving circuit; and
the first power line, the second power line, and the input signal line are all located in the second conductive layer

9. The display substrate of claim 8, wherein the display substrate comprises a display region and a non-display region, the first power line, the second power line, the second conductive portion, and the input signal line are located in the non-display region, the first power line is located on a side of the second conductive portion away from the display region, and the second power line is located on a side of the second conductive portion close to the display region; and
the input signal line is located between the second power line and the second conductive portion.

10. The display substrate of claim 3, wherein the driving circuit layer comprises a semiconductor layer, a third conductive layer, a fourth conductive layer, and a fifth conductive layer sequentially arranged on the base substrate;
active layers of transistors in the gate driving circuit are located in the semiconductor layer;
control electrodes of the transistors, a first plate of a first capacitor and a first plate of a second capacitor in the gate driving circuit are all located in the third conductive layer;
a second plate of the first capacitor and a second plate of the second capacitor in the gate driving circuit are both located in the fourth conductive layer; and
first electrodes and second electrodes of the transistors in the gate driving circuit are all located in the fifth conductive layer.

11. The display substrate of claim 10, wherein each gate driving unit comprises a first transistor, a second transistor, a third transistor, a fourth transistor, a fifth transistor, a sixth transistor, a seventh transistor, and an eighth transistor; and
the fourth conductive layer further comprises a first adapter electrode for connecting a control electrode of the sixth transistor and a first electrode of the second transistor.

12. The display substrate of claim 10, wherein each gate driving unit comprises a first transistor, a second transistor, a third transistor, a fourth transistor, a fifth transistor, a sixth transistor, a seventh transistor, and an eighth transistor; and
a control electrode of the third transistor and a control electrode of the first transistor are connected together to have a one-piece structure, which is connected to a second electrode of the second transistor, and the second electrode of the second transistor is further used as a first clock signal terminal of the gate driving unit.

13. The display substrate of claim 12, wherein the fifth conductive layer further comprises a second adapter electrode, and the second adapter electrode is further used as the second clock signal terminal of the ith gate driving unit and the first clock signal terminal of the (i+1)th gate driving unit, and is connected to a control electrode of the seventh transistor of the ith gate driving unit, a control electrode of the first transistor and a control electrode of the third transistor of the (i+1)th gate driving unit.

14. The display substrate of claim 12, wherein the fifth conductive layer further comprises a third adapter electrode connected to a control electrode of the eighth transistor of the ith gate driving unit and a second electrode of the third transistor of the (i+1)th gate driving unit.

15. The display substrate of claim 12, wherein the fifth conductive layer further comprises a fourth adapter electrode, and the fourth adapter electrode is further used as an output terminal of the ith gate driving unit and an input terminal of the (i+1)th gate driving unit, and is connected to a second electrode of the fifth transistor and a second electrode of the fourth transistor of the ith gate driving unit, and a second electrode of the first transistor of the (i+1)th gate driving unit.

16. The display substrate of claim 10, wherein each gate driving unit comprises a first transistor, a second transistor, a third transistor, a fourth transistor, a fifth transistor, a sixth transistor, a seventh transistor, and an eighth transistor;
an active layer of the fourth transistor and an active layer of the fifth transistor are used in common, and the active layer of the fourth transistor comprises a first semiconductor block, a second semiconductor block, and a third semiconductor block arranged side by side in the first direction at intervals;
orthographic projections of the first semiconductor block, the second semiconductor block and the third semiconductor block on the base substrate overlap with an orthographic projection of a control electrode of the fourth transistor on the base substrate, respectively; and
the orthographic projections of the first semiconductor block, the second semiconductor block and the third semiconductor block on the base substrate overlap with an orthographic projection of a control electrode of the fifth transistor on the base substrate, respectively.

17. The display substrate of claim 4, wherein the first conductive portion comprises a plurality of openings penetrating through the first conductive portion in a thickness direction of the first conductive portion, the plurality of openings comprise a plurality of columns of openings, multiple openings are arranged side by side in a second direction to form a column of openings, and the plurality of columns of openings are arranged side by side along the first direction.

18. The display substrate of claim 4, wherein the display substrate comprises a display region and a non-display region, and initialization signal lines located in the non-display region and pixel driving circuits located in the display region; and
the initialization signal lines are located in the second conductive layer and connected to the pixel driving circuits.

19. A display apparatus, comprising the display substrate of claim 1.

20. The display apparatus of claim 19, wherein the plurality of cascaded gate driving units are arranged side by side along a second direction; and
any one of the plurality of clock signal lines extends along the second direction, and an orthographic projection of each of the clock signal lines in any one group on the base substrate overlaps with an orthographic projection of each gate driving unit on the base substrate.
